(19) United States
(12) Patent Application Publication
(10) Pub. No.: US 2013/0043740 A1
(43) Pub. Date: Feb. 21, 2013

(54) STEERING DEVICE FOR A MOTOR VEHICLE

(71) Applicants: Min Xu, Stuttgart (DE); Torsten Henke, Waiblingen (DE)

(72) Inventors: Min Xu, Stuttgart (DE); Torsten Henke, Waiblingen (DE)

(73) Assignee: ROBERT BOSCH GMBH, Stuttgart (DE)

(21) Appl. No.: 13/579,151

(22) PCT Filed: Jan. 26, 2011
(86) PCT No.: PCT/EP2011/051021

§ 371 Date: Oct. 29, 2012

(30) Foreign Application Priority Data
Feb. 15, 2010 (DE) 10 2010 001 914.3

(51) Int. Cl. H02K 41/02

(52) U.S. Cl. 310/12.04

(57) ABSTRACT

The invention relates to a steering device for a motor vehicle. Said steering device comprises a drive (10), especially an electromotive drive. Said drive is designed to generate torque for assisting the steering of a motor vehicle. According to the invention, the steering device comprises an electromagnetic steering lock (5,7,11,16) comprising a blocking element (11) that can be moved back and forth along a translation axis (25) or about a pivoting axis (23). The blocking element is arranged and designed in such a way as to engage in the drive (22) in a form-fitting and/or force-fitting manner, in order to block the steering. The steering lock comprises at least two, or exactly two, electromagnetic coils (5, 7) that are actively connected to the blocking element, the electromagnetic coils being respectively arranged and designed in such a way as to move the blocking element back and forth when current flows through them. The steering device also comprises a position detection device (48, 50 52, 58) designed to detect at least one position of the blocking element inside the movement interval (26), the movement interval including a blocked state and a released state of the steering device.

### BACKGROUND OF THE INVENTION

The invention relates to a steering device for a motor vehicle. The steering device has a drive, in particular an electromotive drive. The drive is designed to generate, in particular by means of an electric motor, a torque for assisting in steering of a motor vehicle.

Steering devices with an assistance system, for example electrically operated power-steering systems, are used virtually in all vehicles nowadays. Power-steering systems of this kind have, for example, a sensor which detects a steering operation of a driver and controls an electric motor which is arranged on the steering column or a steering rack by means of a control unit. Said electric motor then generates a corresponding torque in order to assist the steering operation. During driving, in particular in hazardous situations, blocking of the steering device should be precluded. In contrast to during driving, blocking of the steering device can advantageously serve as an immobilizer when the vehicle is parked. Steering wheel locking systems which are fitted, in particular, to the steering column have been used for this purpose to date. The steering device can be blocked by interaction between, for example, blocking elements of the steering locking system and mating elements which are additionally provided on the steering column. To this end, the blocking elements are moved to a blocking position or to an unblocking position at a defined time by actuating actuators, for example.

### SUMMARY OF THE INVENTION

According to the invention, the steering device has an electromagnetic steering lock with a blocking element which can be moved to and fro along a translation axis or about a pivot axis. The blocking element is arranged and designed to engage in the drive in an interlocking and/or force-fitting manner in order to block the steering. The steering lock has at least two or exactly two electromagnetic coils which are operatively connected to the blocking element, wherein the electromagnetic coils are each arranged and designed, in the state in which current is supplied, to move the blocking element to and fro. The steering device preferably has a position detection device which is designed to detect at least one position of the blocking element within the movement interval, wherein the movement interval comprises a blocked and a released state of the steering device.

An immobilizer for the motor vehicle can advantageously be formed by the blocking element. The position detection device advantageously has the effect of being able to detect and prevent a change in the position of the blocking element in good time when, during driving of the motor vehicle, the blocking element is moved by means of vibration and thereby could be knocked from the released state to the blocked state. A blocked state of the steering device can be monitored in a discrete or continuous manner with respect to time with further advantage.

The blocking element preferably has an, in particular, ferromagnetic armature, wherein the armature is arranged so as to move to and fro in the operative region of the coils and is connected to the blocking element.

In this embodiment, the position detection device is connected to at least one of the coils and is designed to detect an inductance of the coil and to detect a position of the armature as a function of the inductance of the coil. Detecting the position of the armature and therefore of the blocking element as a function of an inductance of the coil has the advantage that no further detection means, for example a light barrier, for detecting a movement of the blocking element or of the armature have to be a constituent part of the steering device. Therefore, the position of the blocking element can be detected in a manner which is particularly advantageous in respect of outlay.

In a preferred embodiment of the steering device, the position detection device is designed to apply a test signal to at least one of the coils or to both coils, and to detect the inductance of the coil as a function of a response signal from the coil. The test signal is, for example, a square-wave signal, in particular a pulsed test signal, which is designed to detect the inductance of the coil without moving the armature in the process. The test signal can also be a pulse-width-modulated signal.

The test signal preferably comprises voltage pulses and interpulse periods, further preferably the response signal is an induced voltage. The voltage pulses have, for example, a square form.

The test signal has, for example, a period duration of a few milliseconds, for example 10 milliseconds.

The steering device preferably has a power output stage. The coils of the steering device are further preferably connected to the power output stage, wherein the power output stage comprises an H-bridge. The power output stage is designed to supply current to the coils with two current directions which differ from one another, in order to move the blocking element.

The H-bridge of the power output stage preferably comprises four semiconductor switches. The semiconductor switches are formed, for example, by thyristors or by field-effect transistors, in particular MIS field-effect transistors MIS=Metal-Insulator-Semiconductor). Further exemplary embodiments of transistors are an MOS field-effect transistor (MOS=Metal-Oxide-Semiconductor), an IG field-effect transistor (IG=Insulated-Gate), or an IGBT (Insulated-Gate-Bipolar-Transistor).

The steering device preferably has an output for a warning signal and is designed to generate the warning signal as a function of a detected change in position of the blocking element and to output said warning signal at the output end. A control device of the motor vehicle can advantageously effect corresponding countermeasures by virtue of the warning signal, for example the blocking element can be returned to its starting position which is provided during a driving mode, in particular to the released state, by means of a current which controls the steering lock.

The output is further preferably an interface of a field bus, in particular of a CAN bus (CAN=Controller-Area-Network). Further embodiments of a data bus are a LIN bus (LIN=Local-Interconnect-Network) or a FlexRay bus.

In a preferred embodiment of the steering device, the steering device is designed to actuate the power output stage as a function of a detected change in position of the blocking element in order to adjust a predetermined position of the blocking element. The predetermined position of the blocking element is, for example, the released position in which a steering system of the motor vehicle is freely mobile.

In an advantageous embodiment, the steering device preferably has an acceleration sensor, wherein the acceleration sensor is designed to detect vibration of the steering device, and to generate an acceleration signal which represents the vibration. In this embodiment, the steering device is designed to detect the position of the blocking element as a function of the acceleration signal. The acceleration sensor is, for example, an acceleration sensor which is connected to an airbag. Further preferably, the above-described warning signal can be generated as a function of the acceleration signal and further preferably be provided at the output end.

The invention also relates to a method for operating an electromagnetically operated steering inhibitor of an electromotively assisted vehicle steering system.

In the method, a blocking element is moved to and fro by means of two electromagnetic coils in order to block or release the steering system, and a shaft of a drive of the steering assistance system, for example a motor shaft of an electric motor of the drive, is blocked from performing a rotary movement by means of the blocking element in an interlocking manner in the event of blocking, and a position of the blocking element is detected as a function of an inductance of at least one coil.

In the method, a current is preferably generated in the coil by means of a voltage pulse, and the inductance of the coil is detected as a function of a voltage which is dropped across the coil.

### BRIEF DESCRIPTION OF THE DRAWING

The invention will now be described below with reference to figures and further exemplary embodiments. Further advantageous embodiments can be gathered from the dependent claims and from the features disclosed in the description of the figures.

FIG. 1 schematically shows, in an exemplary embodiment of an electromotive drive, a steering device for a motor vehicle having an electromagnetic steering lock;

FIG. 2 shows an exemplary embodiment of a circuit arrangement for an electromagnetic steering lock as shown in FIG. 1;

FIG. 3 schematically shows an exemplary embodiment of signal profiles to the to the circuit arrangement which is shown in FIG. 2;

FIG. 4 shows an exemplary embodiment of signal profiles of the circuit arrangement which is shown in FIG. 2, wherein the blocking element is in a position which blocks the steering system and the inductance of the detected coil is increased in comparison to FIG. 3.

FIG. 5 shows an exemplary embodiment of a blocking element which can be moved to and fro in a pivot axis.

### DETAILED DESCRIPTION

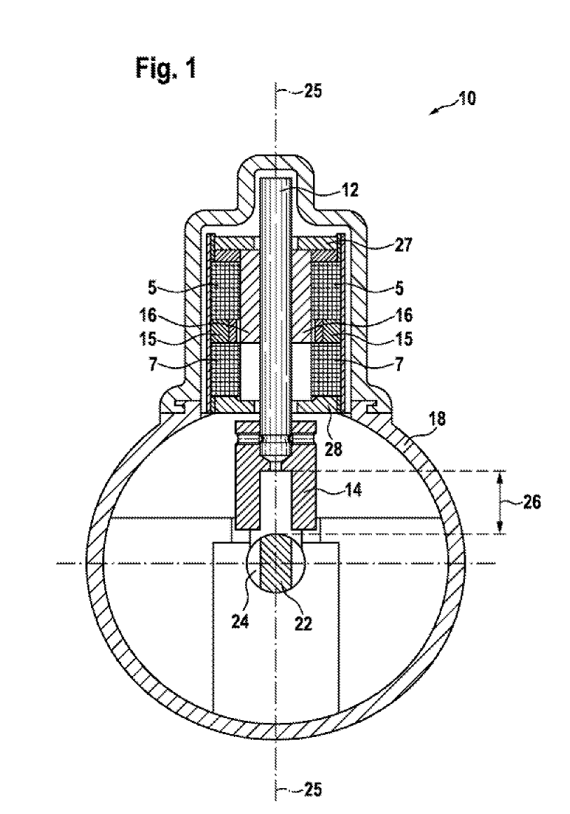

FIG. 1 shows—schematically—a sectional illustration of an exemplary embodiment of an electromotive drive 10 a steering device for a motor vehicle. The drive 10 comprises a housing 18 which accommodates an electric motor having a motor shaft 22. The housing 18 also accommodates two coils 5 and 7. The coils 5 and 7 jointly surround a lumen which extends along a translation axis 25.

The drive 10 also has an elongate blocking element 12 which is mounted such that it can move to and fro along the translation axis 25. The blocking element 12 has a blocking fork 14 at an end which is intended to engage with the motor shaft 22, said blocking fork being designed to engage in a cutout 24 of the motor shaft 22 and, in this way, to secure the motor shaft 22 against a rotary movement in an interlocking manner.

The blocking element 12 is connected to an armature 16 which surrounds the blocking element 12 on a longitudinal section along the translation axis 15 and is arranged in a movable manner in the lumen together with the blocking element 12 such that it can move to and fro along the translation axis 25. The blocking element 12 and the armature 16 can move together along the translation axis 25 in one movement interval 26.

To this end, the drive 10 has two stop bushes 27 and 28 which each have an aperture for guiding the blocking element 12. In this case, the stop bushes 27 and 28 are arranged in such a way that, during the to and fro movement along the translation axis 25, the armature 16 which is connected to the blocking element 12 is secured in an interlocking manner against moving further along the translation axis 25 by means of the stop bushes 27 and 28, such that the to and fro movement along the translation axis 25 cannot exceed the above-described movement interval 26.

An annular permanent magnet 15 is arranged between the coils 5 and 7 along the translation axis 25, said permanent magnet surrounding the lumen on a longitudinal section along the translation axis 25, so that the armature 16 can move through the permanent magnet 15 together with the longitudinal section of the blocking element 12, which is surrounded by said armature, during the to and fro movement along the translation axis 25. A bistable state is formed for the to and fro movement of the blocking element 10 along the translation axis 25 by means of the permanent magnet 15. Specifically, the armature 16 is firmly held in a force-fitting manner in the region of the ends of the movement interval 26 by means of the permanent magnet 15 and is thereby prevented from unintentionally moving—for example due to vibration—along the translation axis 25.

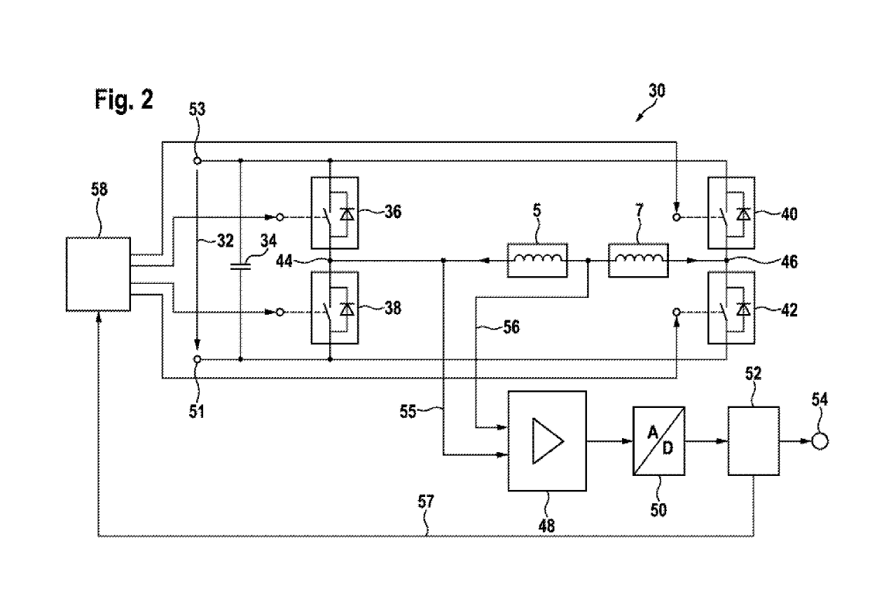

FIG. 2 shows an exemplary embodiment of a circuit arrangement 30 for a steering lock, for example the steering lock which is illustrated in FIG. 1. The circuit arrangement 30 has a power output stage, wherein the power output stage comprises four semiconductor switches, specifically semiconductor switches 36, 38, 40 and 42. The semiconductor switches 36, 38, 40 and 42 are each formed by MOS field-effect transistors (MOS=Metal-Oxide-Semiconductor). The semiconductor switches 36, 38, 40 and 42 are constituent parts of an H-bridge.

The switching paths of the semiconductor switches 36 and 38 are each connected to one another by means of a connection node 44, so that the switching paths 36 and 38 are connected to one another in series by means of the connection nodes 44. The switching paths of the semiconductor switches 40 and 42 are each connected to one another by means of a connection node 46 in such a way that the switching paths of the semiconductor switches 40 and 42 are each connected to one another in series.

The coils 5 and 7 already illustrated in FIG. 1 are connected to one another in series as an output load between the connection nodes 44 and 46.

To this end, a first connection of the coil 5 is connected to the connection node 44, wherein a second connection of the coil 5 is connected to a first connection of the coil 7. A second connection of the coil 7 is connected to the connection node 46.

The coils 5 and 7 each have a non-reactive residual resistance in addition to an inductance, said non-reactive residual resistance not being illustrated in this exemplary embodiment and being negligibly low in practice.

The circuit arrangement 30 also has an amplifier 48 which is connected to the connection node 44, and therefore to the first connection of the coil 5, by means of a connection line 55 at the input end, and to the second connection of the coil 5, and therefore also to the first connection of the coil 7, by means of a connection line 56. The connection lines 55 and 56 therefore tap off a voltage which is dropped across the coil 5.

The amplifier 48 is designed to amplify the voltage which is received at the input end and is dropped across the coil 5, and to transmit said voltage to an analog/digital converter 50 at the output end. The circuit arrangement 30 can have a resistor network, for example a voltage divider, instead of the amplifier 48.

For this purpose, the analog/digital converter 50 is connected, at the input end, to the output of the amplifier 48. The circuit arrangement 30 also has a processing unit 52, in this exemplary embodiment a microprocessor 52. The microprocessor 52 is connected, at the input end, to the output of the analog/digital converter 50. The microprocessor 52 has an output 54. The microprocessor 52 is designed to generate an output signal as a warning signal as a function of the voltage which is dropped across the coil 5, in particular as a function of a change in voltage in the voltage which is dropped across the coil 5, and to provide said output signal at the output 54. The output 54 can be connected, for example, to a data bus, in particular to a field bus, for example to a CAN bus. The microprocessor 52 is connected, at the output end, to a control unit 58 by means of a connection line 57. The control unit 58 is connected, at the output end, to the power output stage, in particular to control connections of the semiconductor switches 36, 38, 40 and 42. An operating voltage for operating the steering lock, for example an on-board electrical system voltage 32, is applied between the connections 51 and 53 during operation of the circuit arrangement 30. The operating voltage is supported by a capacitor 34 which is connected to the connections 51 and 53. When the semiconductor switches 36 and 42 are closed—for example by means of control signals which are generated by the control unit—a current flows from the connection 53, via the semiconductor switch 36, further via the coil 5, the coil 7 via the connection nodes 46 and the semiconductor switch 42, back to the connection 51. When the semiconductor switches 38 and 40 are closed, an inverse current flows through the coils 5 and 7. In the process, the coils 5 and 7 each generate opposing magnetic fields to one another, and therefore the armature 16 which is illustrated in FIG. 1 is moved to or fro—depending on the current direction.

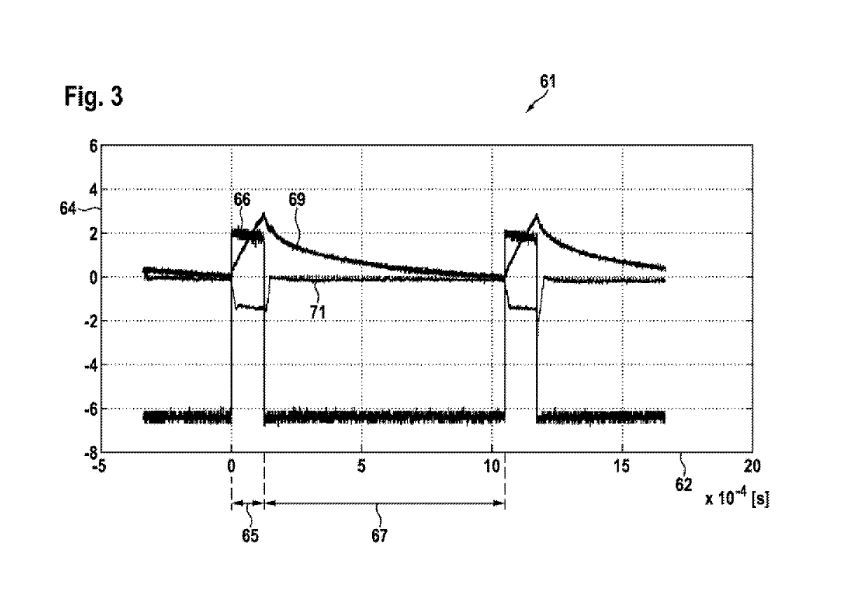

The processing unit 52 is designed to generate, at the output end, a control signal for generating the test single via the connection line 57. The control unit 58, which is connected, at the input end, to the processing unit 52 by means of the connection line 57, is designed to actuate the semiconductor switches 36, 38, 40 and 42 at the output end as a function of the control signal, which is received at the input end, by means of the test signal, and thereby to generate the test signal. For this purpose, the test signal generator 58 is connected, at the output end, to control connections of the semiconductor switches 36, 38, 40 and 42. The test signal, in particular a pulse duration of the test signal, is designed in such a way that the armature and the blocking element cannot be moved. The test pulse of the test signal can—in contrast to the manner illustrated in FIG. 3—have opposite algebraic signs which alternate in succession.

FIG. 3 shows a graph 60 of an exemplary embodiment of signals which can be generated during operation of the circuit arrangement 30 which is shown in FIG. 2. The graph 60 has an abscissa 62 which represents a time axis and an ordinate 64 which represents an amplitude axis. The abscissa 62 shows time values in tenths of a millisecond (10⁻⁴ seconds).

The graph 60 shows a curve 66, wherein the curve 66 represents a control signal for actuating a power output stage of an electromagnetic steering lock. The curve 66 represents, for example, the control signal which has been generated by the control unit 58 in FIG. 2. The curve 66 has control pulses with a control pulse duration 65 and interpulse periods with an interpulse period duration 67.

The graph 60 also shows a current profile 68 which represents, for example, the current which flows through the coils 5 and 7 of the circuit arrangement 30 shown in FIG. 2. The current, represented by the current profile 68, increases continuously during the control pulse duration 65.

The graph 60 also shows a voltage profile 70 which represents a voltage profile which is dropped across a coil through which the current which is represented by the current profile 68 flows. During the control pulse duration 65, a voltage which can be amplified by the amplifier 48 and can further be converted by the analog/digital converter 50 and can further be detected by the processing unit 52 is dropped across the coil, for example the coil 5 in the circuit arrangement 30 in FIG. 2.

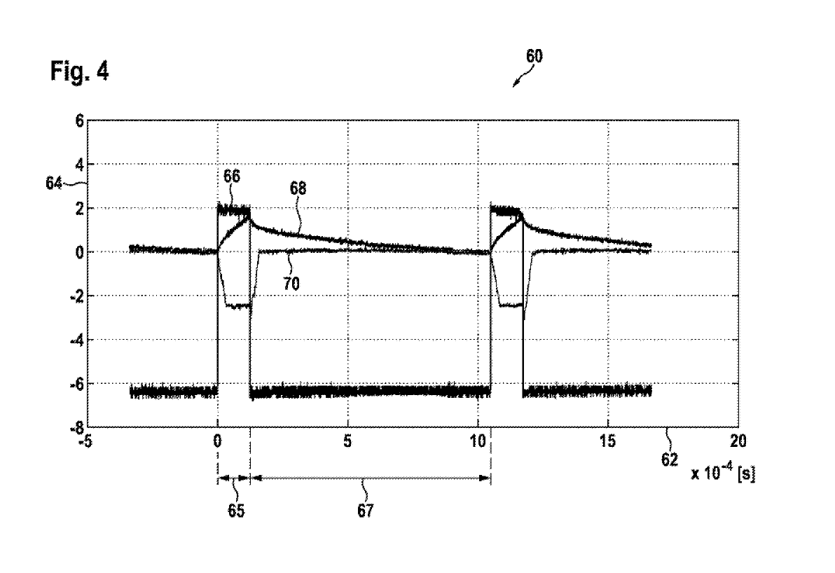

FIG. 4 shows a graph 61 in which the curve 66 is plotted as in the graph 60. The graph 61 also shows a current profile 69 and a voltage profile 71. The current profile 69 and the voltage profile 71 have each been generated as if the armature 16 in FIG. 1 was predominantly inside the lumen which is surrounded by the coil 7. The current profile 68 and the voltage profile 70 have each been generated as if the armature 16 illustrated in FIG. 1 was inside the lumen which is surrounded by the coil 5.

The processing unit 52 illustrated in FIG. 2 is designed to detect the position of the blocking element 12 which is illustrated in FIG. 1 as a function of the voltage profiles 71 and 70, in particular as a function of a difference between the voltage profiles 71 and 70. In this way, the processing unit 52 can be used to detect whether the blocking element 12 in FIG. 1 has moved in the direction of the motor shaft 22 on account of vibration. The processing unit 52 can then generate a warning signal and provide said signal at the output 54 in FIG. 2.

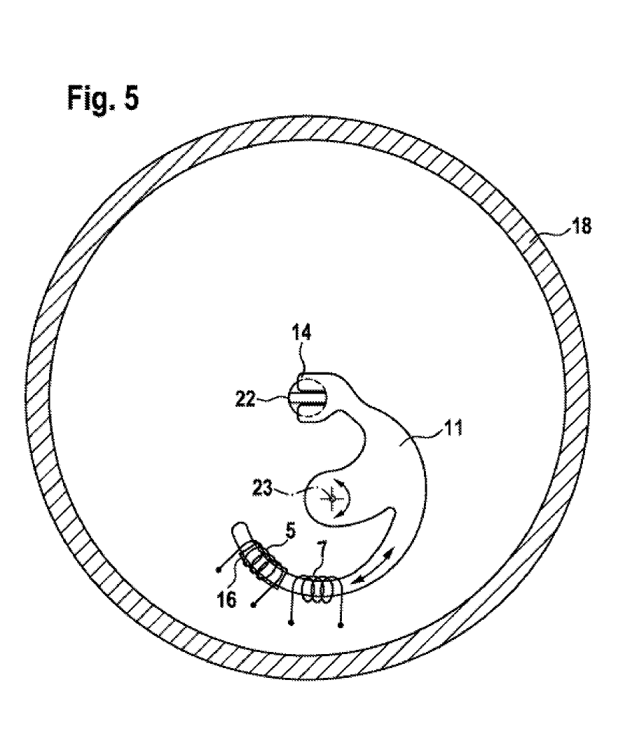

FIG. 5 shows—schematically in a sectional illustration—an exemplary embodiment of a drive of a steering device having a blocking element 11 which is arranged such that it can move to and fro about a pivot axis 23. The blocking element 11 has a section in the form of an arc of a circle which is surrounded by two coils 5 and 7. The blocking element 11 has an armature 16 in the region of an end of the section which is in the form of an arc of a circle, said armature being connected to the blocking element 11 such that it can move to and fro inside a lumen which is surrounded by the coils 5 and 7 and is formed in line with a ring section. The blocking element 11 has a blocking fork 14 which can engage in corresponding cutouts in a motor shaft 22 such that it can pivot about the pivot axis 23, and thereby can secure the motor shaft 22 against a rotary movement in an interlocking manner.

1. A steering device for a motor vehicle, having drive (10) which is designed to generate a torque for assisting in steering of the motor vehicle, characterized in that the steering device has an electromagnetic steering lock (5, 7, 12, 16) with a blocking element (12) which can be moved to and fro along a translation axis (25) or about a pivot axis (23), wherein the blocking element (12) is arranged and designed to engage in the drive in one of an interlocking manner and a force-fitting manner in order to block the steering, wherein the steering lock has at least two electromagnetic coils (5, 7) which interact with the blocking element and which are each arranged and designed, in a state in which current is supplied, to move the blocking element to and fro, wherein the steering device has a position detection device (48, 50, 52, 58) which is designed to detect at least one position of the blocking element within the movement interval (26), wherein the movement interval (26) comprises a blocked and a released state of the steering device.

2. The steering device as claimed in claim 1, characterized in that the blocking element has a ferromagnetic armature (16), wherein the armature (16) is arranged so as to move to and fro in an operative region of the coils (5, 7) and is connected to the blocking element, and the position detection device (48, 50, 52, 58) is connected to at least one of the coils (5, 7) and is designed to detect an inductance of the coil (5, 7) and to detect a position of the armature (16) as a function of the inductance of the coil (5, 7).

3. The steering device as claimed in claim 1, characterized in that the position detection device (48, 50, 52, 58) is designed to apply a test signal (66, 68, 69) to at least one of the coils (5, 7) or to both coils (5, 7), and to detect the inductance of the coil (5, 7) as a function of a response signal (70, 71) from the coil (5, 7).

4. The steering device as claimed in claim 3, characterized in that the test signal (68, 69) comprises voltage pulses (65) and interpulse periods (67), and the response signal (70, 71) is an induced voltage (70, 71).

5. The steering device as claimed in claim 1, characterized in that the coils (5, 7) are connected to a power output stage (36, 38, 40, 42) comprising an H-bridge (36, 38, 40, 42), wherein the power output stage is designed to supply current to the coils (5, 7) with two current directions which differ from one another, in order to move the blocking element.

6. The steering device as claimed in claim 3, characterized in that the steering device has an output (54) for a warning signal and is designed to generate a warning signal as a function of a detected change in position of the blocking element and to output said warning signal at the output (54).

7. The steering device as claimed in claim 5, characterized in that the steering device is designed to actuate the power output stage as a function of a detected change in position of the blocking element in order to adjust a predetermined position of the blocking element.

8. The steering device as claimed in claim 1, characterized in that the steering device has an acceleration sensor, wherein the acceleration sensor is designed to detect vibration of the steering device, and to generate an acceleration signal which represents the vibration, and the steering device is designed to detect the position of the blocking element as a function of the acceleration signal.

9. (canceled)

10. (canceled)

11. A method for operating an electromagnetically operated steering inhibitor (10, 30) of an electromotively assisted vehicle steering system, comprising
moving a blocking element to and fro by means of at least two electromagnetic coils in order to block and release the steering system,
blocking a shaft (22) of a drive of the steering assistance system from performing a rotary movement by means of the blocking element in an interlocking manner in the event of blocking, and
detecting a position of the blocking element as a function of an inductance of at least one coil (5, 7).

12. The method as claimed in claim 11, further comprising generating a current in the coil by means of a voltage pulse, and detecting the inductance of the coil (5, 7) (68, 69) as a function of a voltage (70, 71) which is dropped across the coil (5, 7).

13. The steering device as claimed in claim 2, characterized in that the position detection device (48, 50, 52, 58) is designed to apply a test signal (66, 68, 69) to at least one of the coils (5, 7) or to both coils (5, 7), and to detect the inductance of the coil (5, 7) as a function of a response signal (70, 71) from the coil (5, 7).

14. The steering device as claimed in claim 13, characterized in that the test signal (68, 69) comprises voltage pulses (65) and interpulse periods (67), and the response signal (70, 71) is an induced voltage (70, 71).

15. The steering device as claimed in claim 14, characterized in that the coils (5, 7) are connected to a power output stage (36, 38, 40, 42) comprising an H-bridge (36, 38, 40, 42), wherein the power output stage is designed to supply current to the coils (5, 7) with two current directions which differ from one another, in order to move the blocking element.

16. The steering device as claimed in claim 15, characterized in that the steering device has an output (54) for a warning signal and is designed to generate a warning signal as a function of a detected change in position of the blocking element and to output said warning signal at the output (54).

17. The steering device as claimed in claim 16, characterized in that the steering device is designed to actuate the power output stage as a function of a detected change in position of the blocking element in order to adjust a predetermined position of the blocking element.

18. The steering device as claimed in claim 17, characterized in that the steering device has an acceleration sensor, wherein the acceleration sensor is designed to detect vibration of the steering device, and to generate an acceleration signal which represents the vibration, and the steering device is designed to detect the position of the blocking element as a function of the acceleration signal.

19. The steering device as claimed in claim 1, characterized in that the drive is electromotive.
